(19) United States
(12) Patent Application Publication
(10) Pub. No.: US 2025/0392931 A1
(43) Pub. Date: Dec. 25, 2025

(54) COMMUNICATION NETWORKS FOR AUTOMATED MATERIAL HANDLING SYSTEMS

(71) Applicant: Taiwan Semiconductor Manufacturing Co., Ltd., Hsinchu (TW)

(72) Inventors: Chieh HSU, Hsinchu (TW); Yu-Zhu LIN, Hsinchu (TW); Rong Syuan FAN, Hsinchu (TW); Ching-Jung CHANG, Hsinchu (TW)

(21) Appl. No.: 18/749,433

(22) Filed: Jun. 20, 2024

(51) Int. Cl. H04W 24/08; G05D 1/646; G05D 1/667; G05D 1/86; G05D 107/70; G05D 111/30; H04W 4/40; H04W 36/08; H04W 36/30; H04W 76/19

(52) U.S. Cl. CPC H04W 24/08; G05D 1/646; G05D 1/667; G05D 1/86; H04W 4/40; H04W 36/083; H04W 36/305; H04W 76/19; G05D 2107/70; G05D 2111/32

(57) ABSTRACT

Systems and methods for an improved automated material handling system (AMHS) network are provided herein. The method includes monitoring, by a wireless access point (AP) of an AMHS network, a connectivity status of a first wired communication pathway between the AP and a primary material control system (MCS) controller of the AMHS network. The method further includes determining that the AP has been disconnected from the primary MCS controller for a duration. The method further includes generating and sending an alarm signal in response to the determination that the AP has been disconnected from the primary MCS controller. Responsive to receiving the alarm signal, the AMHS network switches from the primary MCS controller to a secondary MCS controller, the secondary MCS controller being coupled to a hub of the AP via a second wired communication pathway different from the first wired communication pathway.

### BACKGROUND

The following disclosure relates to automated material handling systems (AMHS). The manufacture of semiconductor devices involves the performance of a series of process steps using a variety of high-tech production and metrology tools in a certain order and often within a certain period of time. The primary function of a wafer logistics system in a wafer fabrication facility, or “fab,” is to deliver the wafers to each of the tools at the right time, as well as to track the location and status of the wafers throughout the process. AMHS's are utilized in wafer fabs to carry out the automated functions more efficiently, consistently, and safely than can be done via manual means. The fabrication process often results in the need for cross-floor and cross-phase transportation within a single fab or cross-fab transportation between fabs. This includes utilizing different AMHS's within the same fab or varying across different fabs.

In the advanced landscape of semiconductor fabrication, the communications network for an AMHS plays a pivotal role in achieving operational excellence and manufacturing precision. At the heart of a semiconductor fabrication plant (fab), the AMHS relies on a sophisticated communications network designed to seamlessly integrate various components of the material handling system, including automated guided vehicles (AGVs) or carriers, conveyors, and overhead transport systems that include carriers that able to carry loads (e.g., front opening unified pods (FOUPs), standard mechanical interface (SMIF) pods). This network enables real-time data exchange and coordination, ensuring that materials such as semiconductor wafers and photomasks are transported efficiently and safely between processing stations, inspection units, and storage facilities. Utilizing innovative technologies such as wireless communication protocols, IoT (Internet of Things) integration, and advanced data analytics, the communications network facilitates a synchronized orchestration of the entire material flow within the fab. This not only enhances throughput and reduces material handling times but also minimizes the risk of contamination and damage to sensitive semiconductor materials. Furthermore, by leveraging real-time tracking and monitoring capabilities, the network supports proactive maintenance strategies and dynamic scheduling, optimizing the overall productivity and flexibility of the semiconductor manufacturing process.

### BRIEF DESCRIPTION OF THE DRAWINGS

Aspects of the present disclosure are best understood from the following detailed description when read with the accompanying figures. It is noted that, in accordance with the standard practice in the industry, various features may not be drawn to scale. In fact, the dimensions of the various features may be arbitrarily increased or reduced for clarity of discussion.

FIG. 1 is a schematic block diagram of a communications network for an automated material handling system (AMHS), in accordance with some embodiments.

FIG. 2 is a schematic block diagram of a plurality of hubs and wireless access points of the communications network, in accordance with some embodiments.

FIG. 3 is another schematic block diagram of a plurality of hubs and wireless access points of the communications network, in accordance with some embodiments.

FIG. 4 is a schematic diagram of a carrier of an AMHS that includes local memory and which dynamically stores local maps of portions of an environment, such as a fab, in accordance with some embodiments.

FIGS. 5A-5C are schematic block diagrams of coverage areas for a plurality of wireless access points distributed throughout a fab, wherein a carrier that is equipped with a mobile wireless access point is configured to move into an area of the fab that has lost wireless connectivity, in accordance with some embodiments.

FIGS. 6A-6C are schematic block diagrams of coverage areas for a plurality of wireless access points distributed throughout a fab, wherein a carrier that carries a load that includes a mobile wireless access point is configured to move into an area of the fab that has lost wireless connectivity, in accordance with some embodiments.

FIGS. 7A-7C are schematic block diagrams of coverage areas for a plurality of wireless access points distributed throughout a fab, illustrating how wireless access points are configured to share network signals with nearby wireless access points that have lost wired connectivity in order to expand the working coverage area, in accordance with some embodiments.

FIG. 8 is a flow diagram of a method of operating a network of an AMHS to provide a backup communication network in the event one or more wireless access points of the AMHS loses connectivity, in accordance with some embodiments.

FIG. 9 is a flow diagram of a method of operating a carrier of an AMHS to navigate in an environment using a downloaded map upon detection of a loss of connectivity, in accordance with some embodiments.

FIG. 10 is a flow diagram of a method of operating a network of an AMHS to provide a mobile wireless access point carried by a carrier in the event one or more wireless access points of the AMHS loses connectivity, in accordance with some embodiments.

FIG. 11 is a flow diagram of a method of operating a network of an AMHS including wireless access points that are configured to share network signals with nearby wireless access points that have lost connectivity in order to expand the working coverage area, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed.

The present disclosure relates to the field of automated material handling systems (AMHS), particularly focusing on the enhancement of network architecture to achieve improved levels of robustness and reliability. With the advent of complex manufacturing and distribution environments, such as semiconductor fabrication plants, the demand for more efficient, fail-safe material handling networks has significantly increased. The network architecture presented in this disclosure is specifically designed to meet these needs, providing a comprehensive solution that ensures continuous operation and seamless communication between different components of the AMHS. By addressing many of the limitations of existing networks, this disclosure introduces a novel approach that significantly improves upon the operational integrity, scalability, and adaptability of material handling systems.

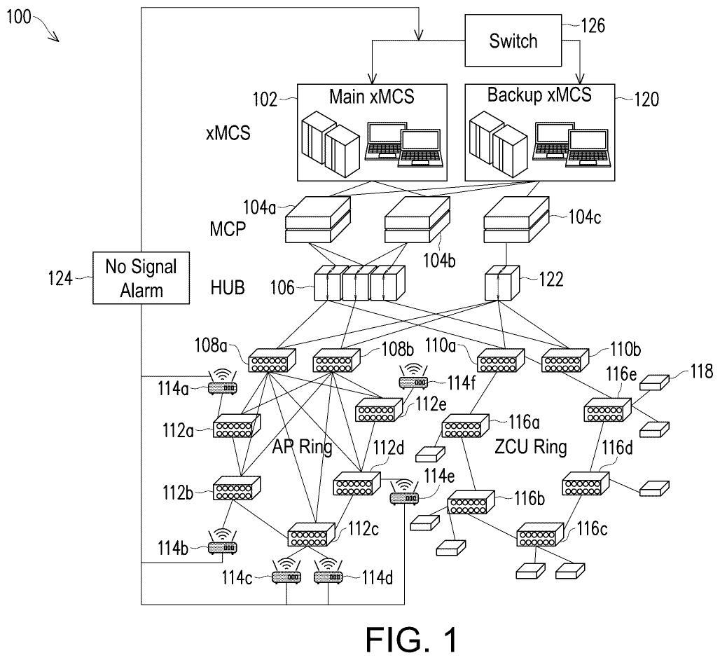

FIG. 1 illustrates a network architecture diagram of an example network 100 for an AMHS, also referred to herein as an AMHS network, according to one non-limiting illustrated implementation. At the core of this architecture is a primary material control system (MCS) controller 102, which acts as the central command unit for the entire network 100. The primary MCS controller 102 may be directly connected to one or more overhead hoist transfer (OHT) controllers 104 (two OHT controllers 104a and 104b shown), each of which plays a pivotal role in managing the physical movement of materials through an environment via carriers on tracks or other vehicles. In at least some implementations, the functionality of the primary MCS controller 102 and the OHT controllers 104 may be divided in other ways, or may be combined into a single controller.

From each OHT controller 104, the network 100 extends to one or more primary main hubs 106 (three primary main hubs shown in FIG. 1). The primary main hub 106 serves as a junction point, facilitating the distribution of communication and control signals to various parts of the network 100 located throughout an environment, such as a semiconductor fabrication plant (or “fab”). Connected downstream to the primary main hub 106 are two distinct sets of source hubs: first and second access point source hubs 108a and 108b, respectively, and first and second zone control unit (ZCU) source hubs 110a and 110b, respectively. These source hubs 108 and 110 are operative to extend the reach of the network 100 to specific operational zones within the environment.

The access point source hubs 108 form a gateway to a ring of access point work hubs 112a-112e, with each access point work hub 112 being directly connected to both of the access point source hubs 108. This configuration ensures a high degree of redundancy and reliability, as communication can be maintained even if one part of the network 100 experiences a failure. The access point work hubs 112 are each coupled to one or more wireless access points 114a-114f, which are configured to communicate with carriers (not shown in FIG. 1) moving on tracks throughout the environment, as well as other components associated with the AMHS or the environment (e.g., tools, storage, etc.) that have wireless communication capabilities. This enables precise tracking and control of material movements.

Similarly, the ZCU source hubs 110 lead to a ring of ZCU work hubs 116a-116e, which are interconnected in a ring topology in the illustrated embodiment. In other embodiments, each of the ZCU work hubs 116 may be additionally or alternatively directly connected to each ZCU source hub 110. This arrangement allows for efficient distribution of control signals to ZCUs connected to each of the ZCU work hubs 116. ZCUs 118 play a role in managing specific zones within the environment, ensuring that materials are handled and routed correctly based on real-time conditions and demands.

Optionally, the network architecture allows for the access point work hubs 112 and source hubs 108, as well as the ZCU work hubs 116 and source hubs 110, to be interconnected in additional or alternative topologies (ring, direct, combination thereof). This flexibility in design further enhances the network's robustness, allowing for multiple paths of communication and control signal distribution, thereby minimizing the risk of system downtime. Further, the number of components is provided as a simplified example, and it should be appreciated that in practice the network architecture includes a larger number of components configured similarly to the depiction in FIG. 1.

When any portion of the AMHS network 100 has a failure or other downtime, it can cause significant damage, loss of product, waste of time and money, and other undesirable effects. To improve the reliability of the AMHS network 100, the network further includes a secondary MCS controller 120, which acts as a backup command unit for the entire network. The secondary MCS controller 120 may be directly connected to the overhead hoist transfer (OHT) controllers 104a and 104b and a secondary OHT controller 104c. In at least some implementations, the functionality of the secondary MCS controller 120 and the secondary OHT controller 104c may be divided in other ways, or may be combined into a single controller. Further, the functionality of the secondary MCS controller 120 and the secondary OHT controller 104c may be similar or identical to the primary MCS controller 102 and OHT controllers 104a-b, respectively.

From the secondary OHT controller 104, the network 100 extends to a secondary main hub 122. The secondary main hub 122 (or multiple hubs) serves as a junction point, facilitating the distribution of communication and control signals to various parts of the network 100 located throughout the environment. Connected downstream to the secondary main hub 122 are the first and second access point source hubs 108a and 108b, respectively, and the first and second ZCU source hubs 110a and 110b, respectively. As discussed above, these source hubs 108 and 110 are operative to extend the network's reach to specific operational zones within the environment by coupling to the access point work hubs 112 and the ZCU work hubs 116.

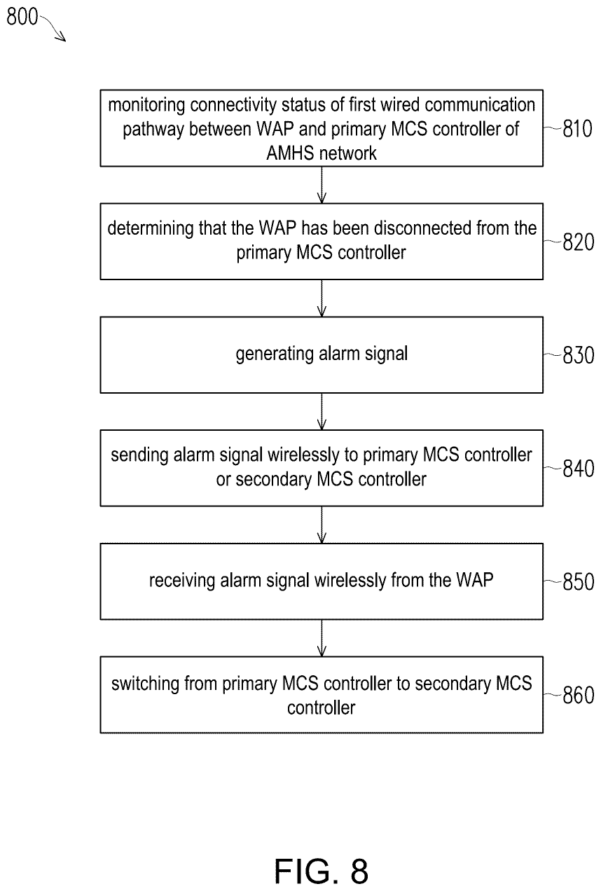

An example of the operation of the network 100 will be discussed below with reference to the flow diagram 800 of FIG. 8. It should be appreciated that the features discussed with reference to FIG. 1 may be performed separately or may be combined with any of the other features discussed herein. Initially, at act 810, a wireless access point, such as the wireless access point 114a, may monitor a connectivity status of a first wired communication pathway between the wireless access point and the primary MCS controller 102 of the AMHS network 100. For example, the first wired communication pathway between the wireless access point 114a and the primary MCS controller 102 runs through the access point work hub 112a, the access point source hubs 108, the primary main hub 106, and the OHT controllers 104. More generally, each of the wireless access points of the AMHS network 100 may be configured to detect when they lose wired connectivity with the MCS controller 102.

At 820, the wireless access point may determine that it has been disconnected from the primary MCS controller 102 for a duration exceeding a predetermined threshold. As non-limiting examples, the predetermined threshold may be 15 seconds, 30 seconds, 1 minute, 2 minutes, 5 minutes, etc. The predetermined threshold may be configurable or may be fixed. Further, the predetermined threshold may be different for individual wireless access points or groups of wireless access points. In response to the determination that the wireless access point has been disconnected from the primary MCS controller 102 for the duration exceeding the predetermined threshold, at act 830 the wireless access point may generate an alarm signal, labeled “No Signal Alarm 124” in FIG. 1. At act 840, this signal may be sent over a wireless communication pathway by the wireless access point that has been disconnected to the primary MCS controller 102 or the secondary MCS controller 120 of the AMHS network 100. As an example, the wireless access point may include a wireless signal transmitter that is different from the wireless transceiver used to communicate with carriers, the wireless signal transmitter being operative to communicate with the MCS controllers or with a switch coupled to the MCS controllers. The wireless communication pathway is different from the first wired communication pathway between the wireless access point that has been disconnected and the primary MCS controller 102. At act 850, the primary MCS controller 102 or the secondary MCS controller 120 may receive the alarm signal wirelessly from the wireless access point that has been disconnected. For example, the primary MCS controller 102 or the secondary MCS controller 120 may include an embedded wireless signal receiver that is configured to receive “no signal” alarms from the wireless access points of the AMHS network 100.

At act 860, responsive to receiving the alarm signal, the network 100 switches control from the primary MCS controller 102 to the secondary MCS controller 120. As discussed above, the secondary MCS controller 120 is communicatively coupled to the access point work hub 112 associated with the wireless access point that has been disconnected via a second wired communication pathway that is different from the wired communication pathway between the primary MCS controller 102 and the access point work hub 112 associated with the wireless access point 114 that has been disconnected, thereby allowing the wireless access point to continue operating normally using the secondary MCS controller 120 until the first communication pathway has been restored. As an example, if the primary main hub 106 becomes non-operational so that the wireless access points 114 cannot communicate with the primary MCS controller 102, the wireless access points 114 would still be operational after the switchover to the secondary MCS controller 120 because they can communicate with the secondary MCS controller via the secondary main hub 122.

After a period of time, the network 100 may determine that the one or more wireless access points that have been disconnected have restored their connection with the primary MCS controller 102 via the first communication pathway. Responsive to such a determination, the network 100 may switch back from the secondary MCS controller 120 to the primary MCS controller 102, such that the wireless access point may resume communicating with the primary MCS controller via the first wired communication pathway.

In at least some implementations, the wireless access point may communicate wirelessly with a switch 126, rather than the MCS controllers 102 or 120 directly, which switch in turn may be operative to cause the network 100 to switch from the primary MCS controller 102 to the secondary MCS controller 120 when the wireless access point becomes disconnected. As an example, the switch may include an embedded wireless signal receiver operative to receive alarm signals from the wireless access points, and to cause the network 100 to switch between the primary MCS controller 102 and the secondary MCS controller 120, as discussed further above.

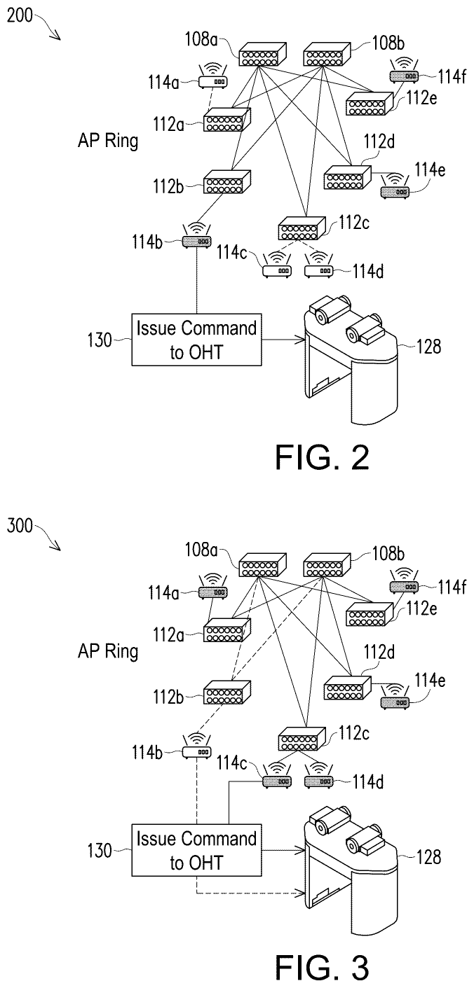

FIG. 2 is a schematic block diagram of a portion 200 of the network 100 shown in FIG. 1, depicting the hubs 108 and 112 and the wireless access points 114, in accordance with some embodiments. The features discussed in relation to FIG. 2 may be implemented separately from or in combination with any of the other embodiments of the present disclosure. In this example, one or more of the access point work hubs 112 may be broken (non-operable) for any reason. For instance, the access point work hubs 112a and 112c may be inoperable. Since the access point work hub 112b is directly connected to the source access point hubs 108, the wireless access point 114b associated with the access point work hub 112b may be able to send commands 130 to a carrier 128 of an overhead hoist transfer (OHT) system or to any other vehicle or device associated with the AMHS system. This is in contrast to a configuration wherein the access point work hubs 112 are connected together in a ring topology. In a ring topology, if access point work hubs 112a and 112c were broken, then the access point work hub 112b and wireless access point 114b would also not be able to communicate through the network since the hub 112b could not send signals through either of the adjacent access point work hubs that are broken. This example illustrates an advantage of coupling the access point work hubs 112 to the source access point hubs 108 directly instead of in a ring topology. As noted above, in at least some implementations, the access point work hubs 112 may be coupled to the source access point hubs 108 directly and via a ring topology to provide additional redundancy.

FIG. 3 is a schematic block diagram of a portion 300 of the network 100, depicting the hubs 108 and 112 and the wireless access points 114 shown in FIG. 1, in accordance with some embodiments. The features discussed in relation to FIG. 3 may be implemented separately from or in combination with any of the other embodiments of the present disclosure. In this example, one or more of the access point work hubs 112 may be broken (non-operable) for any reason. For instance, the access point work hub 112b may be inoperable, which disables wireless access point 114b. In this illustrated example, the carrier 128 may be configured to connect with more than one (e.g., two, three, ten) wireless access points, which allows the carrier 128 to remain connected to the network 100 even if its primary wireless access point (i.e., wireless access point 114b) is inoperable. In the example shown in FIG. 3, if the wireless access point 114b is inoperable, the carrier 128 may still be able to receive commands 130 from the wireless access point 114c and/or other wireless access points of the network that are positioned within range of the carrier 128.

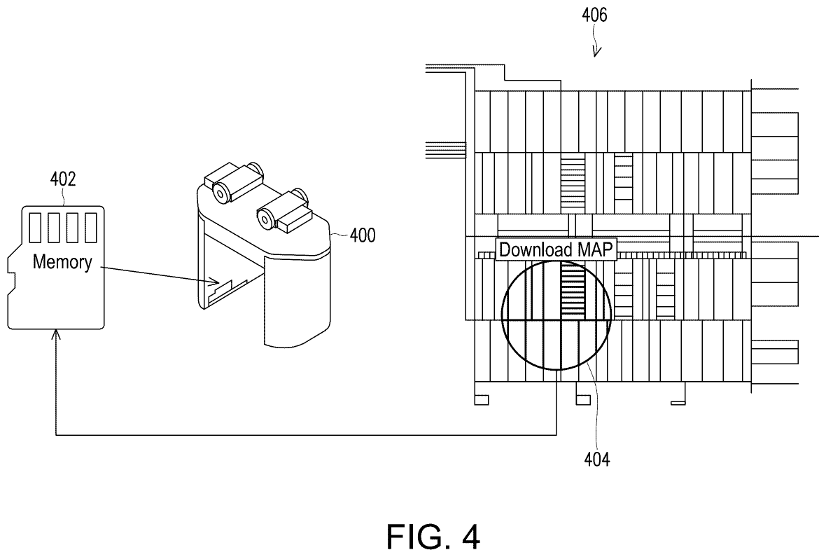

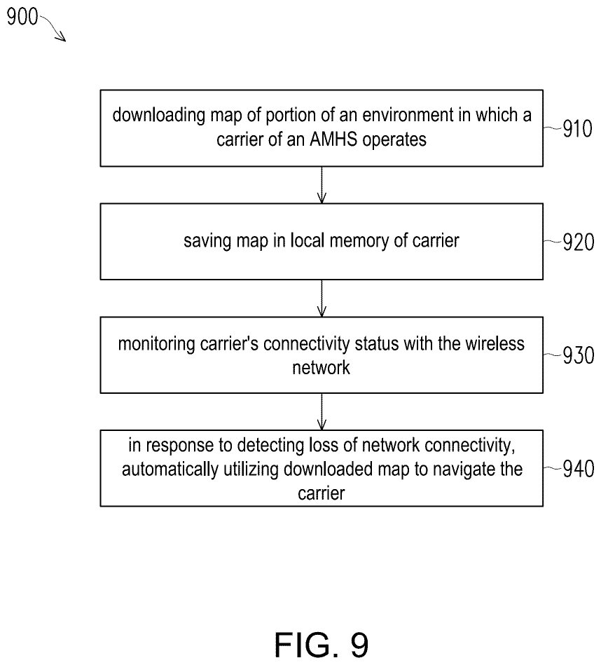

FIG. 4 is a schematic diagram of a carrier 400 of an AMHS that includes local memory 402 and which dynamically stores local maps 404 of portions of an environment 406, such as a semiconductor fab, in accordance with some embodiments. The features discussed in relation to FIG. 4 may be implemented separately from or in combination with any of the other embodiments of the present disclosure. An example of the operation of the carrier 400 will be discussed below with reference to the flow diagram 900 of FIG. 9.

Initially, at act 910, the carrier 400 may periodically download, via a wireless network of the AMHS, the map 404 of a portion of the environment 406 in which the carrier operates. As an example, the periodic downloading of the map 404 may be based on a predetermined schedule (e.g., every 2 minutes, every 3 minutes, every 10 minutes) or may be triggered by the carrier entering a new area of the environment 406 that is not covered by a previously downloaded map that is currently saved in the local memory 402 of the carrier 400. The size and shape of the portion of the total map of the environment that is downloaded at one time may be fixed (e.g., 180 meter radius from vehicle when download initiated, a 400×400 meter square around the carrier, etc.). In other embodiments, the size or shape of the portion of the total map of the environment may be variable. As an example, the size or shape of the portion of the map to be downloaded may vary based on signal strength, available bandwidth, available storage in local memory 402, predicted route(s) of the carrier, or other factors. In at least some implementations, if sufficient memory 402 and bandwidth are available, the carrier 400 may download an entire map of the environment 406.

At act 920, the carrier 400 saves the map 404 in the local memory 402 of the carrier. At act 930, the carrier 400 monitors its connectivity status with the wireless network to determine when the carrier loses connectivity with the wireless network. At act 940, in response to detecting loss of network connectivity, the carrier 400 automatically utilizes the most recently downloaded map 404 to navigate the carrier 400 within the environment 406. Thus, as described further below, the carrier 400 is able to navigate within a limited region of the environment 406 using the downloaded map portion even in circumstances where the carrier has lost connection with the wireless network.

In some embodiments, the carrier 400 may determine whether it is carrying a load when the carrier loses connectivity. Responsive to determining that the carrier 400 is carrying a load when the carrier loses connectivity, the carrier may automatically perform one or more first actions. Responsive to determining that the carrier is not carrying a load when the carrier loses connectivity, the carrier may automatically perform one or more second actions. As an example, when the carrier is carrying a load, the one or more first actions may include moving the carrier to a nearby unloading location within the most recently downloaded map area where the load can be unloaded, unloading the load from the carrier at the unloading location, and moving the carrier to a parking location or a parking loop within the map area at which the carrier will not interfere with traffic of other carriers of the AMHS.

If the carrier is not carrying a load when it loses connectivity, the carrier may perform the second actions, which may include directly moving the carrier to a parking location or a parking loop within the downloaded map area at which the carrier will not interfere with traffic of other carriers of the AMHS. In at least some implementations, the carrier is moved to a parking or “dummy” loop, wherein the carrier substantially continuously moves in an area such that it does not interfere with the traffic of other carriers. In at least some implementations, the carrier 400 may be moved to a parking location wherein the carrier remains in a fixed location.

While in the parking area or while moving in the parking loop, the carrier 400 may detect that its network connectivity has been restored. Responsive to detecting that the network connectivity of the carrier 400 has been restored, the carrier may resume normal navigation operations by receiving communications over the network and may discontinue the use of the most recently downloaded map for navigation within the environment 406.

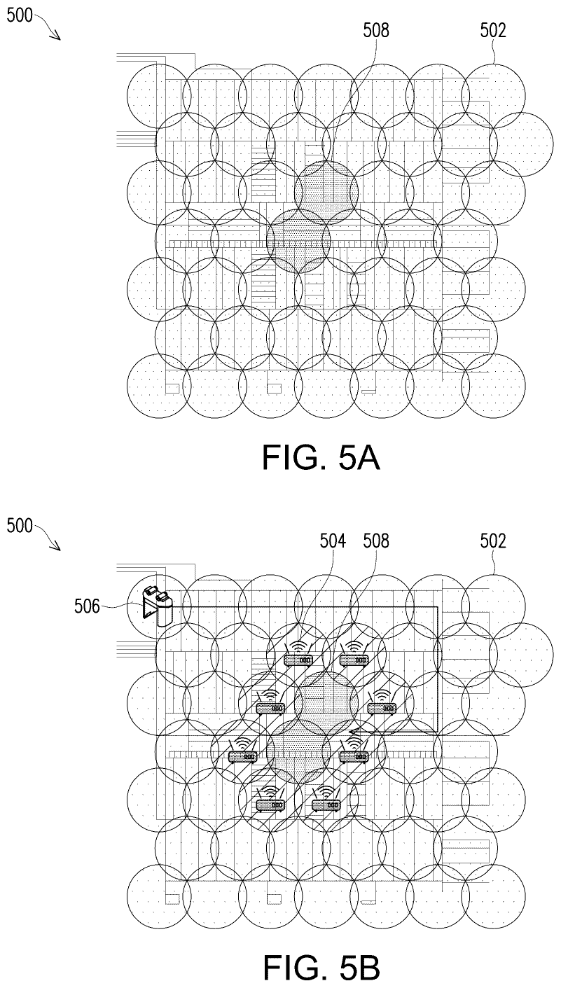

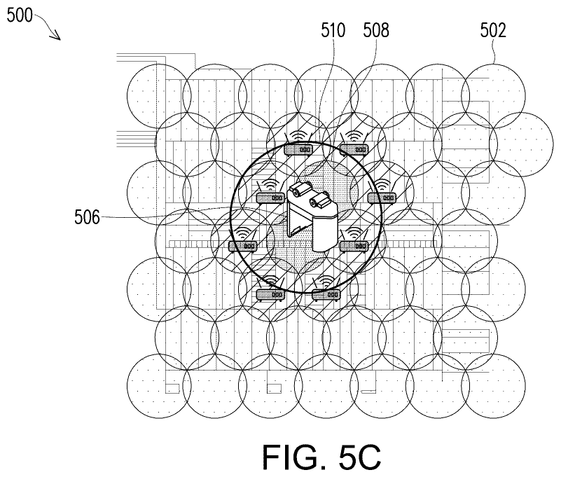

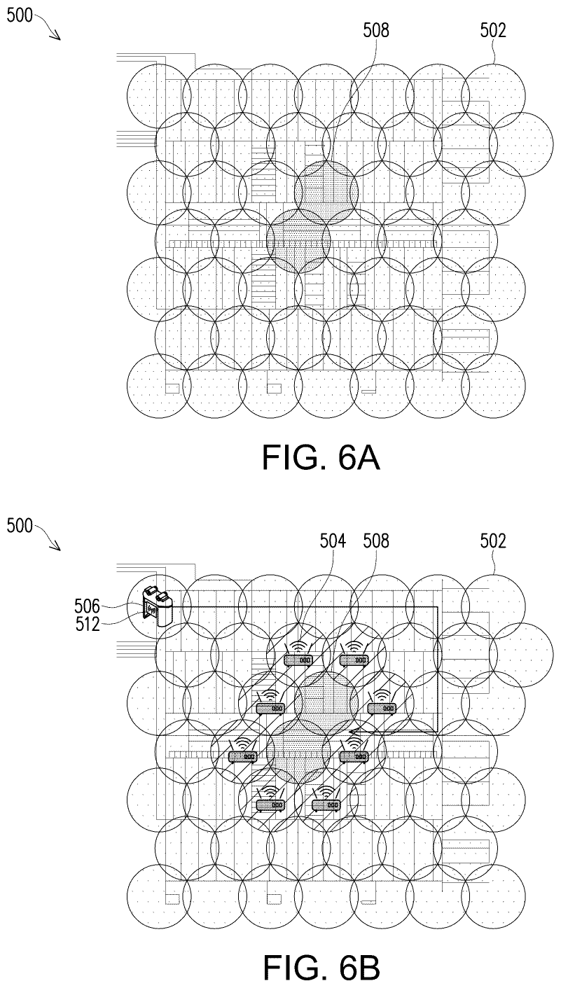

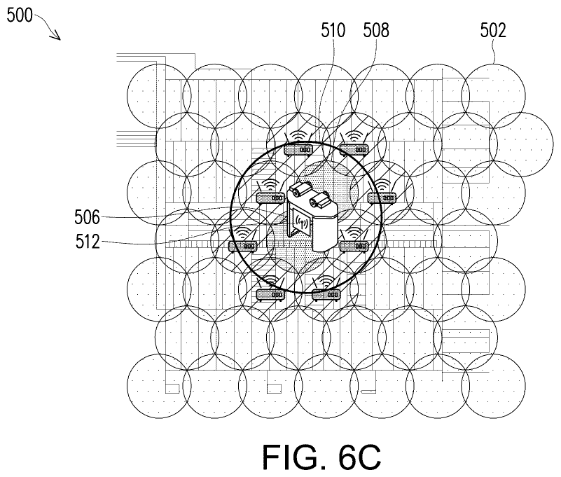

FIGS. 5A-5C and 6A-6C are schematic block diagrams of a plurality of coverage areas 502 (shown as individual overlapping circles) for a plurality of wireless access points (e.g., wireless access point 504 of FIG. 5B) distributed throughout an environment 500, such as a semiconductor fab, wherein a carrier 506 that is configured to carry a mobile wireless access point is further configured to move into an area of the environment that has lost wireless connectivity, in accordance with some embodiments. The features discussed in relation to FIGS. 5A-5C and 6A-6C may be implemented separately from or in combination with any of the other embodiments of the present disclosure.

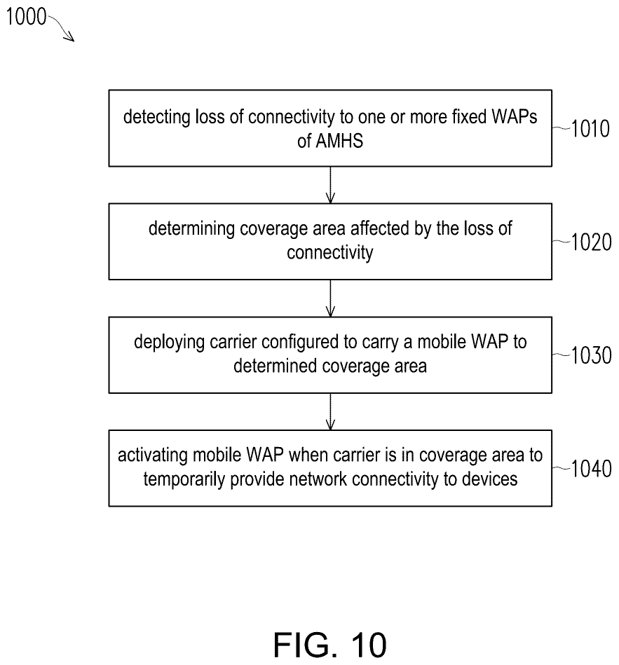

An example of the features depicted in FIGS. 5A-5C and 6A-6C will be discussed below with reference to the flow diagram 1000 of FIG. 10. At act 1010, a component of the AMHS network 100 may detect a loss of connectivity to one or more fixed wireless access points of the AMHS. In FIG. 5A, this is illustrated by the central area 508 (depicted by two overlapping circles), which illustrates that two wireless access points have lost connectivity. At act 1020, the AMHS may determine the coverage area 508 affected by the loss of connectivity of the one or more fixed wireless access points. In FIG. 5A, the coverage area 508 represents the area normally covered by the two wireless access points that have lost connectivity. At 1030, the AMHS may deploy a carrier, such as the carrier 506, that is configured to carry a mobile wireless access point to the determined coverage area 508. This step is shown in FIG. 5B, where the carrier 506 is moved into the area 508 where the inoperable wireless access points are located.

At act 1040, upon arrival of the carrier 506 in the affected coverage area, the carrier may activate the mobile wireless access point carried by the carrier to temporarily provide network connectivity to devices over an area that covers the coverage area 508 affected by the loss of connectivity. In at least some implementations, rather than parking in the coverage area 508, the carrier may move substantially continuously within the coverage area 508 so as to not interfere with traffic of other carriers of the AMHS within the coverage area. Further, depending on the size of the affected coverage area, the system may deploy two or more carriers that carry a wireless access point to provide temporary coverage in affected areas.

The AMHS may monitor a connectivity status of the one or more fixed wireless access points that lost connectivity and determine when they have restored connectivity. Upon determining that connectivity has been restored, the AMHS may deactivate the mobile wireless access point carried by the carrier and move the carrier away from the coverage area.

In some embodiments, such as the embodiment shown in FIGS. 5A-5C, the carrier 506 includes an embedded wireless access point. In other words, the wireless access point is fixedly coupled to the carrier 506. In other embodiments, such as the embodiment shown in FIGS. 6A-6C, the carrier 506 may be configured to carry a load 510 that includes a wireless access point. In such instances, upon detection of an affected coverage area, the carrier 506 may be controlled to first pick up the load 510 that includes a wireless access point, and then controlled to move into the determined coverage area so that the wireless access point of the load 510 carried by the carrier 506 can provide connectivity in the coverage area 508 affected by the broken wireless access points. In the embodiment of FIGS. 6A-6C, any carrier of the AMHS may be used as long as it is able to move to a location to pick up a load that includes a wireless access point. In practice, the AMHS may provide several of such loads distributed throughout an operating environment so that a load containing a wireless access point is readily available throughout the operating environment.

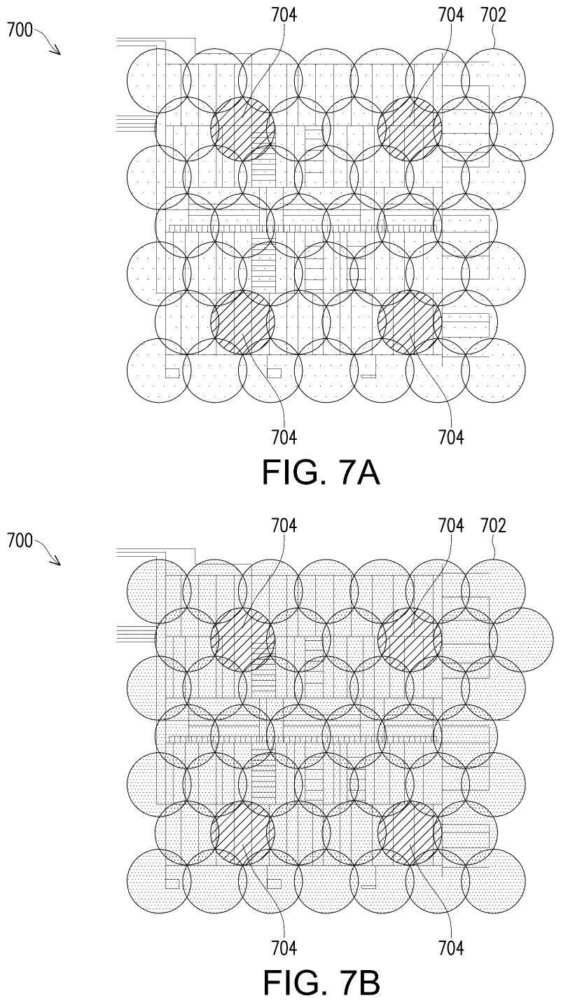

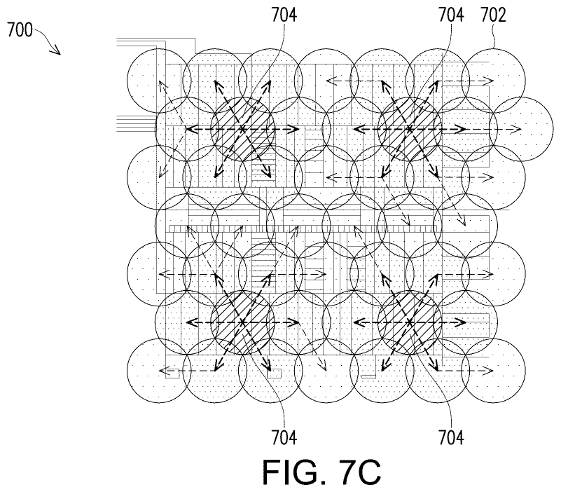

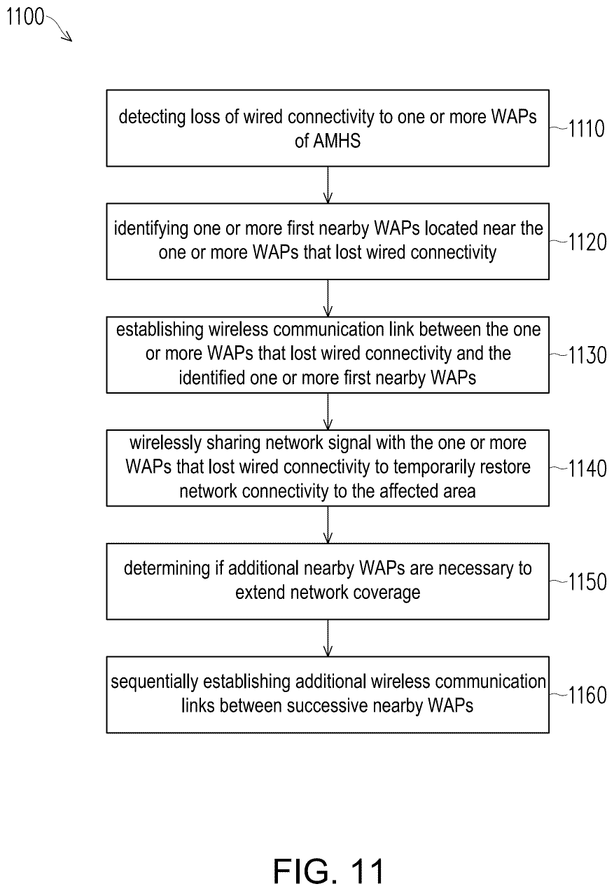

FIGS. 7A-7C are schematic block diagrams of coverage areas 702 for a plurality of wireless access points distributed throughout an environment 700 (e.g., a fab), illustrating a manner in which wireless access points may be configured to share network signals with nearby wireless access points that have lost connectivity in order to expand the working coverage area, in accordance with some embodiments. The features discussed in relation to FIGS. 7A-7C may be implemented separately from or in combination with any of the other embodiments of the present disclosure. An example of the features depicted in FIGS. 7A-7C will be discussed below with reference to the flow diagram 1100 of FIG. 11.

FIG. 7A depicts coverage areas 704 for four source wireless access points and the coverage areas 702 for a plurality of normal or conventional wireless access points that surround the source wireless access points. At 1110, the network may detect a loss of wired connectivity to one or more of the source wireless access points of the AMHS. This is depicted in FIG. 7B, which shows that the four source wireless access points are operational, but the surrounding normal wireless access points have lost wired connectivity to the network.

At 1120, the network may identify one or more first nearby source wireless access points with operational wired connectivity located in proximity to the one or more normal wireless access points that lost wired connectivity. For example, the network may identify the four source wireless access points. At 1130, a wireless communication link may be established between the one or more normal wireless access points that lost wired connectivity and the identified one or more first nearby source wireless access points. At 1140, the one or more source wireless access points may wirelessly share its network signal with the one or more adjacent wireless access points that lost wired connectivity to temporarily restore network connectivity to an affected area.

This process may continue as needed to supply coverage to an even larger area. For example, at act 1150, the network may determine if additional nearby wireless access points are necessary to extend network coverage. If so, at act 1160, the network may sequentially establish additional wireless communication links between successive nearby wireless access points to further share the network signal as needed to supply coverage to the areas covered by the wireless access points that have lost wired connectivity. Once the wired connectivity has been restored, the source wireless access points may stop sharing their network signal and resume normal operation.

An embodiment of a method includes monitoring, by a wireless access point of an automated material handling system (AMHS) network, a connectivity status of a first wired communication pathway between the wireless access point and a primary material control system (MCS) controller of the AMHS network. The method also includes determining, by the wireless access point, that the wireless access point has been disconnected from the primary MCS controller for a duration exceeding a predetermined threshold. The method also includes generating, by the wireless access point that has been disconnected, an alarm signal in response to the determination that the wireless access point has been disconnected from the primary MCS controller for the duration exceeding the predetermined threshold. The method also includes sending, by the wireless access point that has been disconnected, the alarm signal wirelessly to the primary MCS controller or a secondary MCS controller of the AMHS network, where the sending utilizes a wireless communication pathway that is different from the first wired communication pathway between the wireless access point and the primary MCS controller. The method also includes receiving, by the primary MCS controller or the secondary MCS controller, the alarm signal wirelessly from the wireless access point that has been disconnected. The method also includes responsive to receiving the alarm signal, switching from the primary MCS controller to the secondary MCS controller, where in the secondary MCS controller is communicatively coupled to a hub associated with the wireless access point that has been disconnected via a second wired communication pathway that is different from the wired communication pathway between the primary MCS controller and the hub associated with the wireless access point that has been disconnected.

An embodiment of a method includes periodically downloading, by a carrier of an automated material handling system (AMHS) and via a wireless network of the AMHS, a map of a portion of an environment in which the carrier operates. The method also includes saving the map in a local memory of the carrier. The method also includes monitoring, by the carrier, its connectivity status with the wireless network to determine when the carrier loses connectivity with the wireless network. The method also includes in response to detecting loss of network connectivity, automatically utilizing the most recently downloaded map to navigate the carrier within the environment.

An embodiment of a method includes detecting, by an automated material handling system (AMHS) operating in an environment, a loss of connectivity to one or more fixed wireless access points of the AMHS. The method also includes determining, by the AMHS, a coverage area affected by the loss of connectivity of the one or more fixed wireless access points. The method also includes deploying, by the AMHS, a carrier configured to carry a mobile wireless access point to the determined coverage area. The method also includes upon arrival of the carrier in the determined coverage area, activating the mobile wireless access point to temporarily provide network connectivity to devices within the coverage area affected by the loss of connectivity.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
monitoring, by a wireless access point of an automated material handling system (AMHS) network, a connectivity status of a first wired communication pathway between the wireless access point and a primary material control system (MCS) controller of the AMHS network;
determining, by the wireless access point, that the wireless access point has been disconnected from the primary MCS controller for a duration exceeding a predetermined threshold;
generating, by the wireless access point that has been disconnected, an alarm signal in response to the determination that the wireless access point has been disconnected from the primary MCS controller for the duration exceeding the predetermined threshold;
sending, by the wireless access point that has been disconnected, the alarm signal wirelessly to the primary MCS controller or a secondary MCS controller of the AMHS network, wherein the sending utilizes a wireless communication pathway that is different from the first wired communication pathway between the wireless access point and the primary MCS controller;
receiving, by the primary MCS controller or the secondary MCS controller, the alarm signal wirelessly from the wireless access point that has been disconnected; and
responsive to receiving the alarm signal, switching from the primary MCS controller to the secondary MCS controller, where in the secondary MCS controller is communicatively coupled to a hub associated with the wireless access point that has been disconnected via a second wired communication pathway that is different from the wired communication pathway between the primary MCS controller and the hub associated with the wireless access point that has been disconnected.

2. The method of claim 1, wherein the first wired communication pathway includes a first overhead hoist transfer (OHT) system controller between the primary MCS controller and the hub associated with the wireless access point that has been disconnected, and the second wired communication pathway includes a second overhead hoist transfer (OHT) system controller between the secondary MCS controller and the hub associated with the wireless access point that has been disconnected.

3. The method of claim 1, wherein the hub associated with the wireless access point that has been disconnected is one work hub of a plurality of work hubs, each associated with one or more wireless access points, and the AMHS network comprises two source hubs, wherein each of the two source hubs is directly connected to each the plurality of work hubs via a wired communication pathway.

4. The method of claim 1, further comprising a carrier of the AMHS that comprises a wireless transceiver, the method further comprising:
communicating at least one of instructions or data between the wireless transceiver of the carrier and a first wireless access point of the AMHS network; and
communicating at least one of instructions or data between the wireless transceiver of the carrier and a second wireless access point of the AMHS network.

5. The method of claim 1, wherein receiving, by the primary MCS controller or the secondary MCS controller, the alarm signal wirelessly from the wireless access point that has been disconnected, comprises receiving the alarm signal via an embedded signal receiver of the primary MCS controller or the secondary MCS controller.

6. The method of claim 1, further comprising:
sending at least one of instructions or data between the wireless access point that has been disconnected and the secondary MCS controller via the second wired communication pathway.

7. The method of claim 6, further comprising:
determining that the wireless access point that has been disconnected has restored its connection with the primary MCS controller via the first communication pathway;
switching from the secondary MCS controller to the primary MCS controller; and
sending at least one of instructions or data between the wireless access point and the primary MCS controller via the first wired communication pathway.

8. A method, comprising:
periodically downloading, by a carrier of an automated material handling system (AMHS) and via a wireless network of the AMHS, a map of a portion of an environment in which the carrier operates;
saving the map in a local memory of the carrier;
monitoring, by the carrier, its connectivity status with the wireless network to determine when the carrier loses connectivity with the wireless network; and
in response to detecting loss of network connectivity, automatically utilizing the most recently downloaded map to navigate the carrier within the environment.

9. The method of claim 8, further comprising:
determining, by the carrier, whether the carrier is carrying a load when the carrier loses connectivity;
responsive to determining that the carrier is carrying a load when the carrier loses connectivity, automatically performing one or more first actions; and
responsive to determining that the carrier is not carrying a load when the carrier loses connectivity, automatically performing one or more second actions.

10. The method of claim 9, wherein automatically performing first actions comprises:
moving the carrier to a nearby unloading location within the most recently downloaded map where the load can be unloaded;
unloading the load from the carrier at the unloading location; and
moving the carrier to a parking location or a parking loop at which the carrier will not interfere with traffic of other carriers of the AMHS.

11. The method of claim 9, wherein automatically performing second actions comprises:
moving the carrier to a parking location or a parking loop at which the carrier will not interfere with traffic of other carriers of the AMHS.

12. The method of claim 8, further comprising:
detecting a loss of wired connectivity to one or more wireless access points of the AMHS;
identifying one or more first nearby wireless access points with operational wired connectivity located in proximity to the one or more wireless access points that lost wired connectivity;
establishing a wireless communication link between the one or more wireless access points that lost wired connectivity and the identified one or more first nearby wireless access points;
wirelessly sharing, by the identified one or more first nearby wireless access points, network signal with the one or more wireless access points that lost wired connectivity to temporarily restore network connectivity to an affected area;
determining if additional nearby wireless access points are necessary to extend network coverage; and
sequentially establishing additional wireless communication links between successive nearby wireless access points to further share the network signal.

13. The method of claim 8, further comprising:
detecting that the network connectivity of the carrier has been restored; and
responsive to detecting that the network connectivity of the carrier has been restored, resuming normal navigation operations of the carrier and discontinuing the use of the most recently downloaded map for navigation within the environment.

14. The method of claim 8, wherein the periodic downloading of the map is based on a predetermined schedule or is triggered by entering a new area of the environment that is not covered by a previously downloaded map that is saved in the local memory of the carrier.

15. A method, comprising:
detecting, by an automated material handling system (AMHS) operating in an environment, a loss of connectivity to one or more fixed wireless access points of the AMHS;
determining, by the AMHS, a coverage area affected by the loss of connectivity of the one or more fixed wireless access points;
deploying, by the AMHS, a carrier configured to carry a mobile wireless access point to the determined coverage area; and
upon arrival of the carrier in the determined coverage area, activating the mobile wireless access point to temporarily provide network connectivity to devices within the coverage area affected by the loss of connectivity.

16. The method of claim 15, further comprising:
monitoring a connectivity status of the one or more fixed wireless access points that lost connectivity;
determining when the one or more fixed wireless access points have restored connectivity;
deactivating the mobile wireless access point carried by the carrier; and
moving the carrier from the coverage area upon the restoration of connectivity of the one or more fixed wireless access points.

17. The method of claim 15, wherein the mobile wireless access point is coupled to the carrier.

18. The method of claim 15, wherein the mobile wireless access point is coupled to a load carried by the carrier.

19. The method of claim 15, further comprising:
upon arrival of the carrier in the determined coverage area, moving the carrier within the coverage area so as to not interfere with traffic of other carriers of the AMHS within the coverage area.

20. The method of claim 15, further comprising:
detecting a loss of wired connectivity to one or more wireless access points of the AMHS;
identifying one or more first nearby wireless access points with operational wired connectivity located in proximity to the one or more wireless access points that lost wired connectivity;
establishing a wireless communication link between the one or more wireless access points that lost wired connectivity and the identified one or more first nearby wireless access points;
wirelessly sharing, by the identified one or more first nearby wireless access points, network signal with the one or more wireless access points that lost wired connectivity to temporarily restore network connectivity to the affected area;
determining if additional nearby wireless access points are necessary to extend network coverage; and
sequentially establishing additional wireless communication links between successive nearby wireless access points to further share the network signal.
